(19) United States
(12) Patent Application Publication
(10) Pub. No.: US 2008/0250194 A1
(43) Pub. Date: Oct. 9, 2008

(54) TWO-DIMENSIONAL WRITING DATA METHOD FOR FLASH MEMORY AND CORRESPONDING STORAGE DEVICE

(76) Inventor: Ming-Sheng Chen, Taipei (TW)

Correspondence Address: HDSL, 4331 STEVENS BATTLE LANE, FAIRFAX, VA, 22033, US

(21) Appl. No.: 12/060,478

(22) Filed: Apr. 1, 2008

(30) Foreign Application Priority Data
Apr. 3, 2007 (TW) 096111744

(51) Int. Cl. G06F 12/02

(52) U.S. Cl. 711/103; 711/E12.008

(57) ABSTRACT

In a two-dimensional writing data method for a flash memory and a corresponding storage device the storage device includes a plurality of flash modules and a control module. The flash modules are electrically connected to the control module. The control module includes a plurality of buffers and a process unit. The buffers are electrically connected to the respective flash modules and electrically connected to the process unit. The process unit is configured for managing a plurality of memory pages of the flash modules and defining addresses of the memory pages of the flash modules to form a two-dimensional access sequence. The process unit divides data into a plurality of data packets, and transmits the data packets into the buffers in series. The data is written into the corresponding memory pages from the respective buffers, thus the access time of the storage device is decreased.

### BACKGROUND

1. Field of the Invention

The present invention relates to a flash memory, and more specifically, to a storage method and a corresponding device for accelerating the access speed of the flash memory.

2. Description of the Related Art

With the rapid development of the modern science and technology, computers are more and more important in people's life. Especially, in the information working environment, computers usually cooperate with various Software-Hardware, such as Word, PowerPoint, Excel, etc., to be an indispensable device of an industry. Now, portable information devices, such as portable storage devices, have been a useful tool for personal work. Solid-state disk storage devices, such as flash memory, are developed rapidly in the recent years, since they can be carried conveniently and have a large storage capability and a quick access speed. Thus, the solid-state disk storage devices have become main products of the portable storage devices.

Although the flash memory adapted in the portable storage devices has a quicker access speed than conventional mechanical storage devices, the flash memory itself still has a limit in the access speed. The conventional solid-state disk storage devices employ a bus (a connect interface) electrically connected to a buffer, and then the buffer is electrically connected to a flash memory. Thus, data received from the bus is transmitted to the buffer, and then a is written in the memory space of the flash memory.

The transmitting speed of the bus now is increased continuously, such that the data may be transmitted quickly to the buffer. However, the memory space of the conventional flash memory are distributed continuously with addresses, that is, the data is written along the sequence of the memory addresses into the flash memory. Following data should be written after the buffer transmits previous data into the flash memory. Therefore, the following data must be stored provisionally in the buffer and then transmitted to the flash memory, such that the transmitting speed from the buffer to the flash memory is slower greatly than the transmitting speed from the bus to the buffer. The conventional method for writing the data one by one needs more time, and greatly limits the access speed of the flash memory.

What is needed is providing a writing data method, which can solve the above problems.

### BRIEF SUMMARY

A two-dimensional writing data method for a flash memory and a corresponding storage device, in accordance with an exemplary embodiment of the present invention are provided. The storage device includes a plurality of flash modules and a control module. The flash modules are electrically connected to the control module. The control module includes a plurality of buffers and a process unit. Each buffer is electrically connected to a corresponding flash module. Then the buffers are all electrically connected to the process unit. The process unit is configured for managing a plurality of memory pages of the flash modules and defining addresses of the memory pages of the flash modules to form a two-dimensional access sequence. The process unit divides data into a plurality of data packets, and transmits the data packets into the buffers in series. Then the data is respectively written into the corresponding memory pages from the respective buffers, thus the access time of the storage device is decreased.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic, block structure view of a storage device, in accordance with an exemplary embodiment of the present invention;

FIG. 2 is a schematic, enlarged structure view of the storage device of FIG. 1;

FIG. 3 is a schematic, operation chart of the storage device of FIG. 1; and

FIG. 4 is a schematic, block flow chart of a writing data method for the storage device of FIG. 1.

### DETAILED DESCRIPTION

Reference will now be made to the drawings to describe exemplary embodiments of the present writing data method, in detail. The following description is given by way of example, and not limitation.

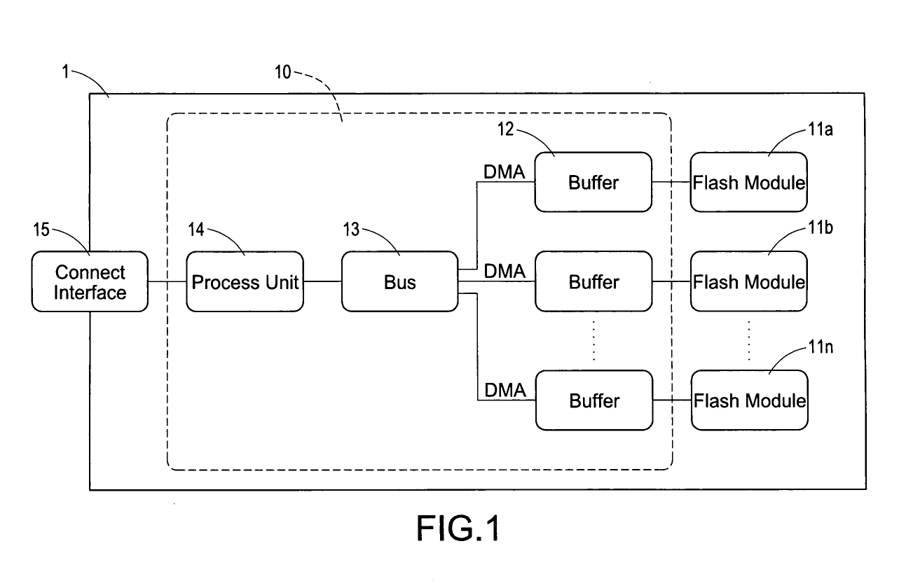

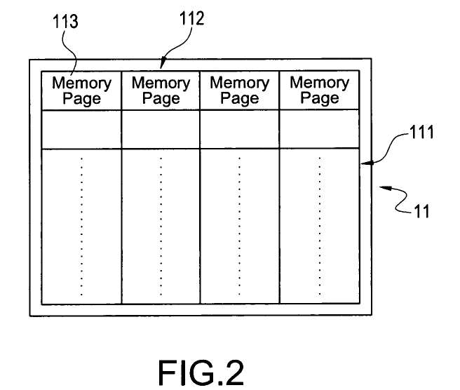

Referring to FIG. 1, a storage device 1, in accordance with an exemplary embodiment of the present invention, is provided. The storage device 1 mainly includes a control module 10 and a plurality of flash modules 11a˜11n. The control module 10 is electrically connected to the plurality of flash modules 11a˜11n. The control module 10 further includes a plurality of buffers 12a˜12n, a bus 13 and a process unit 14. The flash modules 11a˜11n are electrically connected to the respective buffers 12a˜12n. Each flash module 11 is communicated with the corresponding buffer 12 through a single direct memory access (DMA) for transmitting data. Then the buffers 12 are all electrically connected to the process unit 14 through the bus 13 for receiving access instruction, and managing the memory space and the access sequence of the flash modules 11a˜11n through the bus 13 and the corresponding direct memory access. The process unit 14 of the control module 10 is electrically connected to a connect interface 15 for connecting with an outer device (such as computer host) through the connect interface 15 to receive or transmit the data. Furthermore, as shown in FIG. 2, each flash module 11 includes a plurality of memory planes 111 defined therein. In this exemplary embodiment, each flash module 11 includes four memory planes 111, and each memory plane 111 is composed of a plurality of memory pages 112. The memory page 112 has a predetermined memory space with a corresponding memory address.

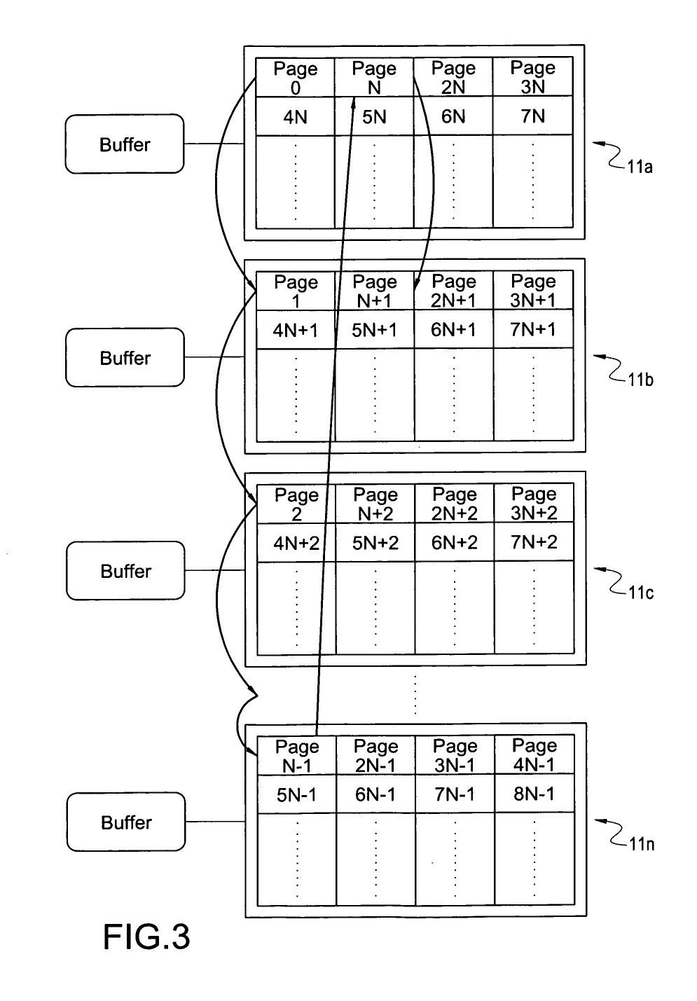

Referring to FIG. 3, the process unit 14 manages the access sequence of the plurality of memory pages 112 of each memory plane 111 of each flash module 11. As shown in FIG. 3, the access sequence of the first memory page 112-a of the first memory plane 111-a of the first flash module 11-a is defined as page0. The access sequence of the first memory page 112-b of the first memory plane 111-b of the second flash module 11-b is defined as page1. The access sequence of the first memory page 112-c of the first memory plane 111-c of the third flash module 11-c is defined as page2, and so on, until defining the access sequence of the first memory page 112-n of the first memory plane 111-n of the last memory flash module 11-n as pageN-1. After defining the access sequences of the first memory pages 112 of the first memory planes 111 of the different flash modules 11, the access sequence of the first memory page 112-a of the second memory plane 111-a of the first flash module 11-a is defined as pageN, and so on. Thus the memory pages 112 of the different flash modules 11 are respectively defined an access sequence in series and in circle to manage the memory space of the plurality of flash modules 11, such that an array with memory sequence is formed, which includes a main longitudinal sequence related to the plurality of flash module, and an accessorial transverse sequence related to the plurality of memory planes of each single flash module.

Therefore, after the process unit 14 receives the outer access instruction and the data through the connect interface 15, the process unit 14 processes the access instruction and the data to find needed memory space and corresponding memory address. Then the process unit 14 divides the data into a plurality of data packets, each less than the memory page 112, and transmits them to the first buffer 12a through the bus 13. The data is written from the first buffer 12a into the memory page 112a of the flash module 11a electrically connected thereto, in other words, the location of page0. At the same time, the process unit 14 transmits directly the unstored data to the following buffer 12b for writing the data into the memory page 112a of the corresponding flash memory 11b, the location of page1 (indicated by the arrowhead of FIG. 3). Then the following unstored data is transmitted directly to the following buffer 12c by the process unit 14 for being written into the memory page 112c of the flash module 11c, the location of page2 (indicated by the arrowhead of FIG. 3), and so on, until transmitting the data to the final buffer 12n by the process unit 14 for writing the data into the memory page 112n of the flash module 1 in, the location of pageN-1 (indicated by the arrowhead in FIG. 3). That is, the process unit 14 transmits the data to the buffers 12a˜12n along the longitudinal sequence, and then the data is synchronously written from the buffers 12a˜12n into the memory pages 12a˜12n of the corresponding flash modules 11a˜11n electrically connected thereto until storing all the data. After the memory planes 111a-1˜111n-1 of all the flash modules 11a˜11n have stored the data, then the process unit 14 writes the unstored data into the memory page 112 of the next memory plane 111a-2 through the first buffer 12a, the location of the pageN (indicated by the arrowhead in FIG. 3). Thus the data is transmitted to the buffers 12a˜12n and written into the flash modules 11a˜11n repeatedly along the longitudinal sequence. However, the data is written into the memory pages 112 of each single flash memory 11 along the transverse sequence related to the different memory planes 111. Therefore, the present writing data method is a two-dimensional access sequence including a main longitudinal sequence related to the sequence of the flash modules and an accessorial transverse sequence related to the sequence of the memory planes of each single flash module. That is, the data is written into the memory planes 111 of each single flash module 11 along the determined sequence. Thus the access time of the present storage device is decreased greatly.

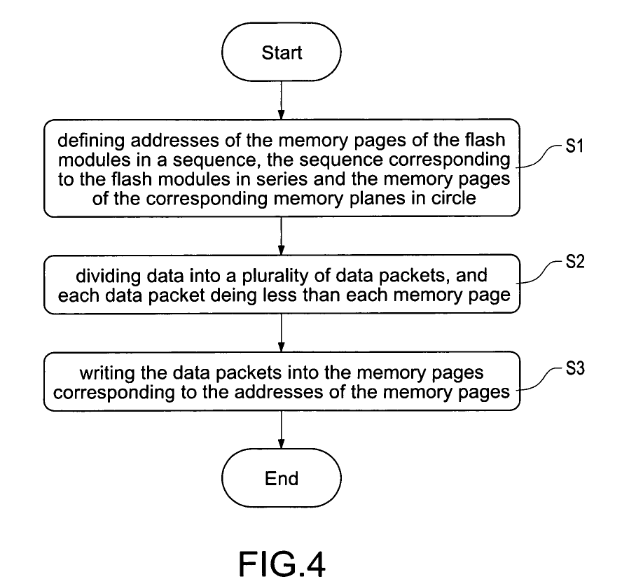

Referring to FIG. 4, firstly, the addresses of the memory pages 112 of the flash modules 11 are defined by the process unit 14 (step S1). The addresses thereof are defined firstly along the longitudinal sequence related to the sequence of the flash modules 11 in series and then in the transverse sequence related to the sequence of the memory pages 112 of the memory planes 111 of each single flash module 11 in circle. Then the data is transmitted from the connect interface 15 into the process unit 14, and divided into a plurality of data packets, each less than the memory page 112 (step S2). Finally, the plurality of data packets are distributed by the process unit 14, and written into the memory pages along a sequence corresponding to the addresses (step S3).

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A two-dimensional writing data method for a flash memory, the method corresponding to a storage device including a plurality of flash modules, a plurality of buffers and a process unit, each flash module including a plurality of memory planes, each memory plane including a plurality of memory pages, the flash modules being electrically connected to the respective buffers and being all electrically connected to the process unit, the method comprising:
a) defining addresses of the memory pages of the flash modules along a sequence, the sequence corresponding to the flash modules and the addresses thereof being defined in series and in circle;
b) dividing data into a plurality of data packets, and each data packet being less than each memory page; and
c) writing the data packets into the memory pages along the sequence corresponding to the addresses of the memory pages.

2. The method as claimed in claim 1, wherein the sequence is a two-dimensional writing sequence including a main longitudinal sequence and an accessorial transverse sequence.

3. The method as claimed in claim 2, wherein the longitudinal sequence relates to the flash modules in series.

4. The method as claimed in claim 2, wherein the transverse sequence relates to the memory planes of each single flash module.

5. A storage device corresponding to a two-dimensional writing data method, comprising:
a plurality of flash modules configured for storing data;
a control module electrically connected to the plurality of flash modules, the control module comprising:
a plurality of buffers electrically connected to the respective flash modules;
a process unit electrically connected to the plurality of buffers, the process unit being configured for managing the memory pages of the flash modules and defining addresses the memory pages of the flash modules to form a two-dimensional writing sequence; and
a bus electrically connected between the process unit and the plurality of buffers, the bus being configured for being a route for transmitting data.

6. The storage device as claimed in claim 5, wherein the control module is electrically connected to a connect interface.

7. The storage device as claimed in claim 6, wherein the connect interface is electrically connected to the process unit.

8. The storage device as claimed in claim 5, wherein each flash module is a flash memory and includes a plurality of memory planes.
